(19) United States
(12) Patent Application Publication
(10) Pub. No.: US 2007/0001124 A1
(43) Pub. Date: Jan. 4, 2007

(54) Device and method for locating seats in an enclosed space

(76) Inventors: Abraham Moreno Sobrino, Coyoacan (MX); Gerardo Camacho Santelioes, Coyoacan (MX)

Correspondence Address: BIRCH STEWART KOLASCH & BIRCH, PO BOX 747, FALLS CHURCH, VA, 22040-0747, US

(21) Appl. No.: 10/536,392

(22) PCT Filed: Apr. 15, 2004
(86) PCT No.: PCT/MX04/00038

§ 371 Date: Sep. 5, 2006

(30) Foreign Application Priority Data
Jun. 16, 2003 (MX) PA/A/2003/005444

(51) Int. Cl. F21K 2/00; G09F 13/20

(52) U.S. Cl. 250/484.4; 428/690; 428/195.1; 40/542; 250/462.1

(57) ABSTRACT

The invention describes a device for finding seats and advertising trademarks and items in seats indoors, particularly closed premises such as theaters, movie theaters, auditoriums, restaurants, discotheques or the like. The device comprises an element with a photoluminescent means placed over a portion of the element surface, in order to place over a headrest or any other part of a seat surface which is in closed premises. In different embodiments of the invention, the element comprises a cover, a cushion, a patch, a label or a patterned or printed fabric or the like. The invention also describes a method for finding seats and advertising trademarks or items on seats in closed premises comprising the steps of: placing said device directly over the headrest or any other part of a seat surface in closed premises; exposing said device to ambient light for a predetermined time; and turning ambient light off whereby the spectator covers the photoluminescent part of the device and/or seat, thereby allowing a spectator entering the closed premises, to easily visualize the vacant places through the visual indication, respectively, of the seat occupancy status or the glow of the trademark or item with the photoluminescent means of the sign, trademark or distinctive sign over the headrest or any other part of the seat surface.

The present invention refers generally to devices that provide visual information regarding occupancy on indoor seats and, more specifically, to a device with a photoluminescent means that allows to find indoor vacant seats, particularly closed premises such as theaters, movie theaters, auditoriums, restaurants, discotheques or the like.

The present invention also refers to devices that visually provide a means for displaying trademarks and items indoors, and, more specifically, to a device with a photoluminescent means that enables to advertise trademarks and items in indoor seats, particularly closed premises such as theaters, movie theaters, auditoriums, restaurants, discotheques or the like.

The invention also refers to a method for finding seats and advertising trademarks or items on indoor seats, specifically closed premises such as theaters, movie theaters, auditoriums, restaurants, discotheques or the like.

### BACKGROUND OF THE INVENTION

Nowadays, there are few ways of finding seats in indoor and dark places, particularly closed premises such as theaters, movie theaters, auditoriums, restaurants or discotheques. The solutions for the problem of finding vacant seats while the lights are off are generally very complex and expensive to acquire, operate and maintain. Besides, they lack versatility or they are likely to experience electromechanical breakdowns.

The prior art describes apparatuses and methods for finding indoor seats. An example of such apparatus and method is disclosed in U.S. Pat. No. 6,140,921 to Baron. Said Patent describes an indicator and display system for providing information regarding occupancy on indoor seats through multi-colored lights mounted on the top of the seat and controlled by sensors and switches electrically connected to the seat. However, said apparatus and system for providing seat occupancy status information on indoor seats is enabled only by an insulated electrical power means whose mechanism is complicated, and expensive to acquire, operate and maintain, it lacks versatility and is likely to experience electromechanical breakdowns.

The prior art has also considered an apparatus with photoluminescent means for indication purposes in dark and indoor places. An example of said apparatus is disclosed in U.S. Pat. No. 6,358,563 to Van Duynhoven. This document describes an apparatus that, in this case, is a self-luminescent signage or indicia that absorbs ambient light and emits it in the darkness, used to display trademarks or emergency signs with signaling purposes. However, the use of said apparatus with photoluminescent means has not been considered for signaling purposes or for finding seats in theaters, movie theaters, auditoriums, restaurants or discotheques or, generally, dark and indoor places. Furthermore, such apparatus is particularly suited to architectural applications.

The prior art has also considered the use of trademarks or identification distinctive signs in a headrest cover. An example of such an apparatus is disclosed in U.S. Patent Application No. US/2002/0074838 to Whiting. Said document describes a headrest cover for vehicle seats with a surface that comprises identifying trademarks or distinctive signs having parts of differing light reflectivity.

With the purpose of eliminating these and other inconveniences and also of allowing different uses, a new method and device have been developed, which this application refers to, consisting in a photoluminescent silk screen printing printed on its surface, in order to cover a seat headrest located in a dark and indoor place and a method for finding seats or advertising trademarks or distinctive signs or items on indoor seats.

### BRIEF DESCRIPTION OF THE INVENTION

The characteristic features of this novel device and method for finding seats or advertising trademarks or items on indoor seats are clearly shown in the following description and in the accompanying drawings.

It is a first object of the present invention to provide a device with a photoluminescent means located over the device surface covering a seat headrest, in order to find vacant seats indoors, specifically closed premises such as theaters, movie theaters, auditoriums, restaurants, discotheques or the like, through the visual sign of the photoluminescent means that indicates whether or not seats are vacant over the headrest or seat top.

It is a second object of the present invention to provide a device with a photoluminescent means placed over the device surface covering a headrest or any other part of a seat surface for advertising trademarks or items on indoor seats, particularly closed premises such as theaters, movie theaters, auditoriums, restaurants, discotheques or the like, through the visual indication of glow of the photoluminescent means with a trademark or distinctive sign over the headrest or any other part of the seat surface.

It is a third object of the present invention to provide a method for finding seats in closed premises through the visual sign of the photoluminescent means indicating whether or not seats are vacant, which is placed over the surface of a device covering the headrest or top of each seat in closed premises.

It is a fourth object of the present invention to provide a method for advertising trademarks or items on seats within closed premises, through the visual indication of the glow of the trademarks or distinctive signs of the photoluminescent means which is placed over the device surface covering the headrest or over any other part of the seat surface in closed premises.

### DETAILED DESCRIPTION OF THE DRAWINGS

The details of the invention are described next, making reference to the drawings, which help to understand the novel aspects of the same:

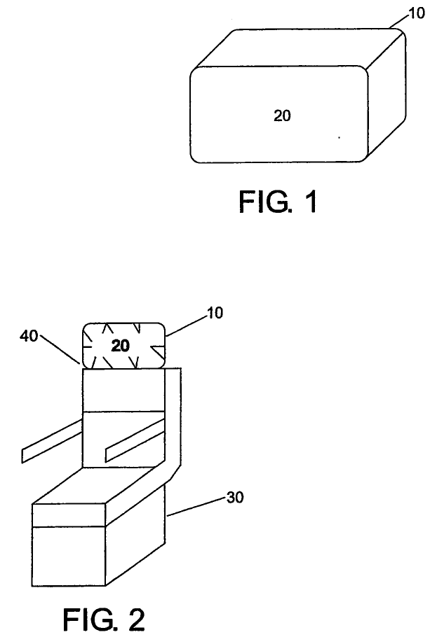

FIG. 1 shows a diagram of a device with a photoluminescent means placed over a portion of the device surface in order to cover a seat headrest. In FIG. 1, the device 10 utilized to cover a seat headrest, in this case, a cover, has a photoluminescent silk screen printing 20 printed on its surface. The photoluminescent silk screen printing 20 printed is a distinctive sign and is located, preferably, on the center of a device surface where the head of the spectator rests.

FIG. 2 shows a diagram of a device with a photoluminescent means located over a portion of the device surface covering a seat headrest in closed premises. In FIG. 2, the device 10 utilized to cover the seat headrest, in this case, a cover, has a photoluminescent silk screen printing 20 printed on its surface and is placed over the seat 30 headrest 40 located in closed premises, such as a theater.

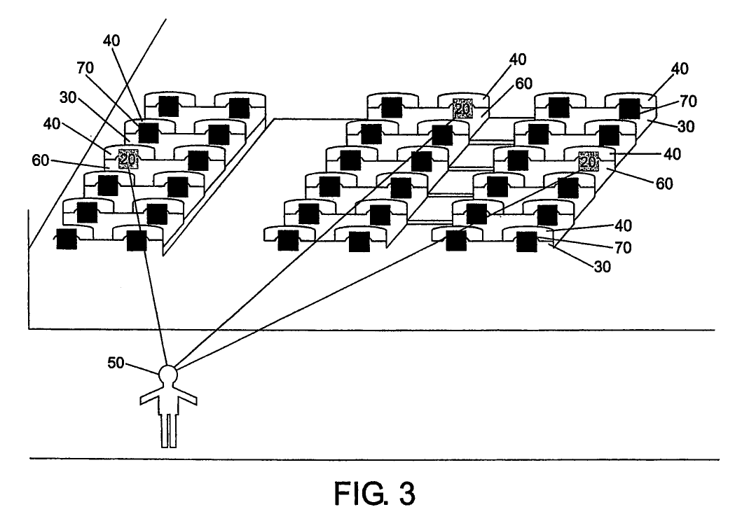

FIG. 3 shows a diagram of the visual indication of the seat occupancy status 30, as well as the glow of a trademark or item from the perspective of a spectator 50 who has just entered closed premises like, for example, a theater, through a photoluminescent means 20 of a sign, trademark or distinctive sign over the seat 30 headrest 40.

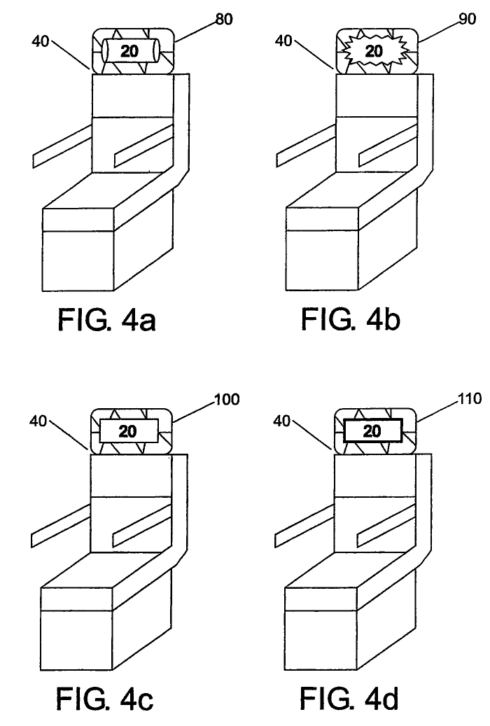

FIGS. 4a-4d show diagrams of different embodiments of elements that characterize the device in order to find indoor seats and advertise trademarks or items on indoor seats such as a cushion 80, a patch 90, a label 100 or patterned or printed fabric 110, with a photoluminescent means 20 placed over the seat 30 headrest 40 or seat top in closed premises.

### DETAILED DESCRIPTION OF THE INVENTION

According to a first aspect of the invention, making reference to FIGS. 1 and 2, the device 10 is characterized by an element that, in a first embodiment, is a cover, which is placed over a seat 30 headrest 40 indoors, particularly in closed premises such as theaters, movie theaters, auditoriums, restaurants, discotheques or the like, which has a photoluminescent means like a silk screen printing 20 with a photoluminescent ink to find seats in closed premises. The ink pigment consists preferably of a compound containing thin crystals of zinc sulfite, whose unique and combined properties allow the provision of a photoluminescent glow. In other embodiments, the ink pigment that provides the photoluminescent glow consists of a composition containing thin crystals of zinc sulfite, copper and manganese, or thin crystals of calcium, strontium sulfite and bismuth.

The photoluminescent ink keeps glowing during about the first 25 minutes of the beginning of each show in, for example, a theater, and it gets recharged autonomously with the lights of the theater which are turned on at the end of each show to carry out the maintenance of the theater. The photoluminescent glow of the device is best achieved if the device is exposed to a light source rich in ultraviolet rays.

As it may be observed in FIG. 3, upon entering closed premises like a theater with the lights off at the beginning of a show, a spectator 50 may easily visualize the vacant seats 60 due to the strategic place where a distinctive sign with a photoluminescent means 20 is placed over the device 10 surface, which is placed over the seat 30 headrest 40. The area where the distinctive sign is to be placed is, preferably, the center of the cover where the head of the spectator rests. Upon seating, the spectator 70 covers the center and photoluminescent portion of the device, thereby allowing the spectator 50 entering the theater to easily visualize the vacant seats.

To keep the device in good working order, it is essential that the lights of the place where the seat headrest device is to be used be off, in order to allow the photoluminescent means placed with the photoluminescent ink to glow and to take advantage of the darkness to highlight and find the vacant seats in the closed premises.

The manufacture of the device with its characteristic element in a first embodiment, in this case, the cover which is placed over the seat headrest, consists in the making of a cover, which may be made of different sizes or shapes, according to the proportions and measures of the seat headrest which is to be covered, and it also may be made of different materials such as fabric or elastic material but preferably of a wear-resistant material that can absorb a photoluminescent ink, and the photoluminescent ink silk screen printing of the distinctive sign on the center of the cover surface where the head of the spectator rests.

In other embodiments of the device for finding seats indoors and making reference to FIGS. 4a-4d, the device comprises an element with a photoluminescent means which is a cushion 80, a patch 90, a label 100 or a patterned or printed fabric 110 with the photoluminescent means over a surface portion of said element in order to cover the headrest 40 or be placed, preferably, on the center top of the seat surface 30 in closed premises.

According to a second aspect of the invention, making reference to FIGS. 1 and 2, the device 10 is characterized by an element that, in a first embodiment, is a cover, which is placed over a seat headrest indoors, specifically closed premises such as theaters, movie theaters, auditoriums, restaurants, discotheques, or the like, which has a photoluminescent means such as silk screen printing 20 with a photoluminescent ink to advertise trademarks or items in the closed premises that, due to its characteristics, works with the lights, thereby allowing to have a greater presence in a place not typically considered for advertising.

As it may be observed again in FIG. 3, on entering closed premises such as a theater with the lights off at the beginning of a show, a spectator 50 may easily visualize the glow of the trademarks or items advertising due to the strategic place where a trademark or distinctive sign with a photoluminescent means 20 is placed over the device 10 surface, which is placed over the headrest 40 or any other part of the seat surface 30. The area where the device with the photoluminescent means of a trademark or distinctive sign is placed is, preferably, the center portion of the seat where the head of the spectator rests. However, all the area of the seat surface may be used to place a device with the photoluminescent means of a trademark or distinctive sign. Upon seating, the spectator 70 covers the center portion and the photoluminescent portion of the device, thereby covering part or all the advertisement. However, the vacant seats allow the spectator 50 entering the theater to be immediately presented with trademark or items advertisements and allows such trademarks or items to have a greater presence in places where they could not be advertised before.

In order to keep the device in good working conditions, it is essential that the lights of the place where the device is to be placed over the headrest or any other part of the seat surface be off most of the time, in order to allow the photoluminescent means placed with the photoluminescent ink to glow and to take advantage of the darkness to advertise trademarks or items in closed premises.

In other embodiments of the device for advertising trademarks and items in indoor seats and making reference to FIGS. 4a-4d, the device comprises an element with a photoluminescent means which is a cushion 80, a patch 90, a label 100, or a patterned or printed fabric 110 with the photoluminescent means 20 over a surface portion of said element in order to cover the headrest 40 or be placed over any other part of the seat 30 surface in closed premises.

According to a third aspect of the invention, the present invention refers to a method for finding seats indoors, specifically closed premises, comprising the steps of: placing a device comprising an element with a photoluminescent means on its surface over the headrest or top center of each seat, where the spectator head rests, in closed premises that lights up and darkens; exposing the device with the photoluminescent means on its surface by turning on ambient light for a predetermined time; and turning off ambient light. Upon turning off ambient light, the head of the spectator covering a portion of the photoluminescent device allows the spectator entering closed premises to easily visualize the vacant seats through a visual indication of the seat occupancy status of the photoluminescent means of the distinctive sign over the headrest or center top of the seat.

In other embodiments of the device for finding seats indoors and making reference to FIGS. 4a-4d, the device comprises an element with a photoluminescent means which is a cushion 80, a patch 90, a label 100 or a patterned or printed fabric 110 with the photoluminescent means over a portion of said element surface to cover a headrest 40 or be placed, preferably, over the center top of the seat 30 surface in closed premises.

According to a fourth aspect of the invention, the present invention refers to a method for advertising trademarks or items on indoor seats, particularly closed premises, which comprises the steps of: placing a device comprising an element with a photoluminescent means on its surface over the headrest or any other part of the surface of each seat in closed premises that lights and darkens; exposing the device with the photoluminescent means on its surface by turning on ambient light for a predetermined time; and turning off ambient light. Upon turning off the ambient light, a spectator that has just entered the closed premises is presented with trademark or items advertisements on the vacant seats through the visual indication of glow of the photoluminescent means with a trademark or distinctive sign on the device surface which is placed over the headrest or any other part of the seat surface.

In other embodiments of the device for advertising trademarks or items indoors and making reference to FIGS. 4a-4d, the device comprises an element with a photoluminescent means that is a cushion 80, a patch 90, a label 100 or a patterned or printed fabric 110 with the photoluminescent means over a portion of the surface of said element in order to cover the headrest 40 or be placed over any other part of the seat surface 30 in closed premises.

1. A device for finding indoor seats, particularly closed premises, characterized because it comprises:
an element with a photoluminescent means placed over a portion of the element surface, to place over a seat headrest located in closed premises.

2. A device according to claim 1, further characterized because the element comprising the photoluminescent means is a cover.

3. A device according to claim 1, further characterized because the element comprising the photoluminescent means is a label.

4. A device according to claim 1, further characterized because the element comprising the photoluminescent means is a patch.

5. A device according to claim 1, further characterized because the element comprising the photoluminescent means is a cushion.

6. A device according to claim 1, further characterized because the element comprising the photoluminescent means is a patterned or printed fabric or the like.

7. A device according to claim 1, characterized because the photoluminescent means is placed on a surface portion of the element where the head of a spectator rests.

8. A device according to claim 1, characterized because the photoluminescent means uses a photoluminescent ink with a pigment that absorbs ambient light and emits it in the darkness.

9. A device according to claim 1, characterized because the pigment of the photoluminescent ink consists of a chemical compound containing copper and thin crystals of zinc sulfite or thin crystals of calcium, strontium sulfite and bismuth.

10. A device according to claim 1, characterized because the photoluminescent means placed over a portion of the element surface is a distinctive sign.

11. A device according to claim 1, characterized because the element with photoluminescent means is made of a material that can absorb photoluminescent ink and is wear-resistant.

12. A device according to claim 1, characterized because the closed premises is a theater, movie theater, auditorium, restaurant, discotheque or like indoor premises.

13. A device according to claim 2, characterized because the photoluminescent means is a silk screen printing printed on the cover surface.

14. A device for advertising trademarks or items on seats indoors, specifically closed premises, characterized by:
an element with a photoluminescent means placed over a portion of the element surface in order to place over a headrest or any other part of a seat surface which is located in closed premises.

15. A device according to claim 14, further characterized because the element comprising the photoluminescent means is a cover.

16. A device according to claim 14, further characterized because the element comprising the photoluminescent means is a label.

17. A device according to claim 14, further characterized because the element comprising the photoluminescent means is a patch.

18. A device according to claim 14, further characterized because the element comprising the photoluminescent means is a cushion.

19. A device according to claim 14, further characterized because the element comprising the photoluminescent means is a patterned or printed fabric or the like.

20. A device according to claim 14, characterized because the photoluminescent means uses a photoluminescent ink with a pigment that absorbs ambient light and emits it in the darkness.

21. A device according to claim 14, characterized because the pigment of the photoluminescent ink consists of a chemical compound containing copper and thin crystals of zinc sulfite or thin crystals of calcium, strontium sulfite and bismuth.

22. A device according to claim 14, characterized because the photoluminescent means place over a portion of the element surface is a trademark or distinctive sign.

23. A device according to claim 14, characterized because the element that comprises the photoluminescent means is from a material that can absorb ink and is wear-resistant.

24. A device according to claim 14, characterized because the closed premises is a theater, movie theater, auditorium, restaurant, discotheque or like indoor premises.

25. A device according to claim 15, characterized because the photoluminescent means is a photoluminescent silk screen printing printed on the surface of the cover.

26. A method for finding seats indoors, particularly closed premises, comprising the steps:
placing a device comprising an element with a photoluminescent means on its surface over the headrest or top of each seat, where the spectator head rests in closed premises that lightens up and darkens;
exposing the device comprising the element with photoluminescent means on its surface turning on ambient light for a predetermined time;
whereby the spectator head covers a portion of the photoluminescent means, thereby allowing a spectator entering the closed premises to easily visualize the vacant seats, through a visual indication of the seat occupancy status of the photoluminescent means over the headrest or center top of the seat.

27. A method according to claim 26, further characterized because the element comprising the photoluminescent means of the device is a cover, label, patch, cushion, patterned or printed fabric or the like.

28. A method for advertising trademarks or items on indoor seats, particularly closed premises, comprising the steps of:
placing a device comprising an element with a photoluminescent means on its surface over the headrest or any other part of the surface of each seat in closed premises that lightens up and darkens;
exposing the device comprising the element with the photoluminescent means on its surface by turning on ambient light for a predetermined time;
turning off ambient light;
whereby a spectator entering the closed premises is presented with trademark and items advertisement on vacant seats, through the visual indication of the glow of the photoluminescent means with a trademark or distinctive sign over the headrest or any other part of the seat surface.

29. A method according to claim 28, further characterized because the element comprising the photoluminescent means of the device is a cover, label, patch, cushion, patterned or printed fabric or the like.
